(19) United States
(12) Patent Application Publication
(10) Pub. No.: US 2022/0230190 A1
(43) Pub. Date: Jul. 21, 2022

(54) METHOD AND SYSTEM FOR RAPID ANALYSIS OF CUSTOMER INFORMATION

(71) Applicant: Qatar Foundation for Education, Science and Community Development, Doha (QA)

(72) Inventors: Jim Jansen, Doha (QA); Soon-gyo Jung, Doha (QA); Joni Salminen, Doha (QA)

(21) Appl. No.: 17/579,039

(22) Filed: Jan. 19, 2022

Related U.S. Application Data
(60) Provisional application No. 63/139,116, filed on Jan. 19, 2021.

(51) Int. Cl. G06Q 30/02; G06Q 10/06

(52) U.S. Cl. CPC G06Q 30/0201; G06Q 10/06393

(57) ABSTRACT

A method and system for rapid customer data analysis. The method includes providing at least one processor capable of connecting to a network, connecting the processor to the network and providing a user interface in operable communication with the processor. Additionally, the method includes providing one or more processor-executable instructions to the processor, the one or more processor-executable instructions includes at least one algorithmic process for analyzing data in a manner that allows for descriptive and predictive analysis. Customer behavioral data and at least one Key Performance Indicator are provided to the processor. Analyzing customer behavioral data in view of the provided Key Performance Indicator includes identifying customer behavioral patterns, automatically classifying the behavioral patterns identified into discrete segments and compressing the resulting discrete segments into narrower, unique segments. A report is generated that includes patterns identified and actionable applications of the report.

### CROSS-REFERENCE TO RELATED APPLICATIONS

The present application claims priority to and the benefit of U.S. Provisional Application No. 63/139,116 filed on Jan. 19, 2021, the entirety of which is herein incorporated by reference.

### BACKGROUND

Many businesses routinely collect customer behavioral data, along with customer demographics from their customers. Business-to-Consumer (B2C) companies have a tremendous amount of information about their customers but also face significant lag time in deriving value from this data in the form of immediately actionable insights. For example, a retail company that fulfills orders online logs customer purchasing behavioral data. A telecom company stores data concerning data plans and usage. In each of these examples, the businesses have numerous touchpoints for each customer, including variables such as inquiries or purchases, usually along with some set of demographic data (e.g., age, gender, nationality). As such, these businesses possess rich stores of possible insights into their customer base for a variety of commercial activities, such as upselling, cross-selling, customer retention programs, brand enhancement, outbound marketing, and customer relationship management.

In response to the increase in availability of customer data, there has been a corresponding increase in statistical analysis tools which one can use to analyze the collected customer data and also conduct customer segmentation. Customer segmentation is the process of dividing customers into distinct segments based on a shared attribute or behavior to more effectively market to that specific segment. However, the existing statistical analytics tools have several undesirable draw backs. For instance, existing tools, require a high degree of sophistication and skill that are difficult to acquire and maintain. These tools are only useful to a small percentage of organizations who have the ability to acquire the prerequisite skill set. Additionally, existing tools require a significant amount of time to generate reports concerning the data analyzed. This leads to lag time for marketers to receive the reports and companies missing critical revenue generating opportunities concerning their customers. Another drawback is that existing tools only provide reports that are generally exploratory, high-level, and not immediately actionable to marketers. The lack of immediately actionable information requires an additional step on the part of the marketers to determine how to apply the insights generated by the customer segmentation tools. This can be both costly and inefficient.

Accordingly, there is a need for a data analysis and customer segmentation tool for rapid analysis of customer data that solves the above-mentioned drawbacks.

### SUMMARY

The present disclosure provides a new and innovative method and system for rapidly analyzing customer behavior information and generating immediately actionable insights. The present disclosure allows for the critically needed business capability of rapid and accurate segmentation of customer behavioral and associated demographic data based on business key performance indicators (KPIs). KPIs are metrics that businesses use to gauge the process and/or success of customer initiatives and projects. An aim of the provided method is to allow for cost effective, rapid and accurate research of customer behavior and associated demographic information. The method may be utilized to generate immediately actionable insights that an organization can use to better tailor customer initiatives and projects to market to specific customer segments. The customer segmentation tool could be used by researchers, companies, non-profit organizations and governmental agencies to better tailor outreach to the public and target specific demographics with marketing and outreach campaigns.

The present disclosure provides methods for rapid customer segmentation which involves providing a tailored interface to allow for customer behavior and demographic information to be uploaded, inputting customer information and company specific KPIs, providing a combination of standardized backend algorithmic processes for analyzing data, identifying unique customer behavioral patterns, automatically classifying customer preferences into discrete segments (including predicting possible future preferences), compressing the resulting customer segments into the smallest but still unique number, generating report with immediately actionable insights based on information analyzed. The disclosed method is carried out by utilizing at least one processor that is capable of executing processor-executable instructions. Additionally, the processor must also be capable of connecting to a network, for example the internet, in order to carry out the disclosed method. Finally, the method according to the present disclosure may utilize a user interface, such as a graphical user interface (GUI), to allow a user to interact with and to input information to the processor.

The present disclosure encompasses several advantages over existing customer segmentation tools such as, providing an intuitive and user friendly interface to input data which reduces the prerequisite skill necessary to utilize the disclosed research tool. Additionally, the present disclosure utilizes company specific KPIs which provides immediately actionable and contextualized insights. This provides the user of the customer segmentation tool with immediately applicable information and does not require additional analysis. Finally, the present disclosure allows for rapid analysis of customer behavior data and customer segmentation. This ensures insights are generated immediately and users of the method do not to miss critical revenue generating opportunities concerning their customers.

In light of the disclosure, and without limiting the scope of the invention in any way, in a first aspect of the present disclosure, which may be combined with any other aspect listed herein unless specified otherwise, a method for rapid customer data analysis includes providing at least one processor capable of connecting to a network, connecting the processor to the network thereby facilitating communication with at least one remote device and providing a user interface in operable communication with the processor, where the user interface is used to input commands to the processor.

In another aspect of the present disclosure, which may be used in combination with any other aspect or combination of aspects listed herein, the method includes providing one or more processor-executable instructions to the processor, where providing the processor-executable instructions causes the processor to execute the instructions in response to the input where the one or more processor-executable instructions includes at least one algorithmic process for analyzing data in a manner that allows for descriptive and predictive analysis.

In another aspect of the present disclosure, which may be used in combination with any other aspect or combination of aspects listed herein, the method includes providing customer behavioral data, via the user interface, to the processor, providing at least one Key Performance Indicator, via the user interface, to the processor and analyzing customer behavioral data in view of the provided Key Performance Indicator, via the at least one algorithmic process executed by the processor, where analyzing the customer behavioral date includes identifying customer behavioral patterns as it relates to the provided Key Performance Indicator, automatically classifying the behavioral patterns identified into discrete segments and compressing the resulting discrete segments into narrower, unique segments.

In another aspect of the present disclosure, which may be used in combination with any other aspect or combination of aspects listed herein, the method includes generating a report of the patterns identified, including actionable applications of the report.

In another aspect of the present disclosure, which may be used in combination with any other aspect or combination of aspects listed herein, the user interface is selected from the group of a graphical user interface, an auditory user interface and a virtual user interface.

In another aspect of the present disclosure, which may be used in combination with any other aspect or combination of aspects listed herein, the key performance indicators are user-specific key performance indicators.

In another aspect of the present disclosure, which may be used in combination with any other aspect or combination of aspects listed herein, providing customer behavioral data to the processor may be accomplished using the at least one remote device, via the network.

In another aspect of the present disclosure, which may be used in combination with any other aspect or combination of aspects listed herein, the generated report includes a list of the patterns identified and a list of discrete classification segments provided to the user utilizing the user interface.

In another aspect of the present disclosure, which may be used in combination with any other aspect or combination of aspects listed herein, the generated report is a virtual persona of customer attributes provided via the user interface.

In another aspect of the present disclosure, which may be used in combination with any other aspect or combination of aspects listed herein, the generated report includes at least one actionable initiative.

In another aspect of the present disclosure, which may be used in combination with any other aspect or combination of aspects listed herein, a computer-implemented method includes providing at least one processor capable of connecting to a network, providing a user interface in operable communication with the processor, where the user interface is used to input commands to the processor and providing one or more processor-executable instructions to a processor, where providing the processor-executable instructions causes the processor to execute the instructions in response to the input where the one or more processor-executable instructions includes at least one algorithmic process for analyzing data in a manner that allows for descriptive and predictive analysis.

In another aspect of the present disclosure, which may be used in combination with any other aspect or combination of aspects listed herein, the method includes providing customer behavioral data, via the user interface, to the processor, providing at least one Key Performance Indicator, via the user interface, to the processor and analyzing customer behavioral data in view of the provided Key Performance Indicator, via the at least one algorithmic process executed by the processor, where analyzing the customer behavioral date includes identifying customer behavioral patterns as it relates to the provided Key Performance Indicator, automatically classifying the behavioral patterns identified into discrete segments and compressing the resulting discrete segments into narrower, unique segments.

In another aspect of the present disclosure, which may be used in combination with any other aspect or combination of aspects listed herein, the method includes generating a report of the patterns identified, including actionable applications of the report.

In another aspect of the present disclosure, which may be used in combination with any other aspect or combination of aspects listed herein, the user interface is selected from the group of a graphical user interface, an auditory user interface and a virtual user interface.

In another aspect of the present disclosure, which may be used in combination with any other aspect or combination of aspects listed herein, the key performance indicators are user-specific key performance indicators.

In another aspect of the present disclosure, which may be used in combination with any other aspect or combination of aspects listed herein, providing customer behavioral data to the processor may be accomplished using the at least one remote device, via the network.

In another aspect of the present disclosure, which may be used in combination with any other aspect or combination of aspects listed herein, the generated report includes a list of the patterns identified and a list of discrete classification segments provided to the user utilizing the user interface.

In another aspect of the present disclosure, which may be used in combination with any other aspect or combination of aspects listed herein, the generated report is a virtual persona of customer attributes provided via the user interface.

In another aspect of the present disclosure, which may be used in combination with any other aspect or combination of aspects listed herein, the generated report includes at least one actionable initiative.

In another aspect of the present disclosure, which may be used in combination with any other aspect or combination of aspects listed herein, a customer behavior analysis system includes at least one processor capable of connecting to a network, at least one remote device capable of connecting to the network and a user interface operatively coupled to the processor, the interface configured to receive an input.

In another aspect of the present disclosure, which may be used in combination with any other aspect or combination of aspects listed herein, the system includes a memory device storing processor-executable instructions, where the one or more processor-executable instructions includes at least one algorithmic process for analyzing data in a manner that allows for descriptive and predictive analysis, where the analysis includes providing customer behavioral data, via the user interface, to the processor, providing at least one Key Performance Indicator, via the user interface, to the processor, analyzing customer behavioral data in view of the provided Key Performance Indicator, via the at least one algorithmic process executed by the processor, where analyzing the customer behavioral date includes identifying customer behavioral patterns as it relates to the provided Key Performance Indicator, automatically classifying the behavioral patterns identified into discrete segments, compressing the resulting discrete segments into narrower, unique segments and generating a report of the patterns identified, including actionable applications of the report.

In another aspect of the present disclosure, which may be used in combination with any other aspect or combination of aspects listed herein, the user interface is selected from the group of a graphical user interface, an auditory user interface and a virtual user interface.

In another aspect of the present disclosure, which may be used in combination with any other aspect or combination of aspects listed herein, the key performance indicators are user-specific key performance indicators.

In another aspect of the present disclosure, which may be used in combination with any other aspect or combination of aspects listed herein, providing customer behavioral data to the processor may be accomplished using the at least one remote device, via the network.

In another aspect of the present disclosure, which may be used in combination with any other aspect or combination of aspects listed herein, the generated report includes a list of the patterns identified and a list of discrete classification segments provided to the user utilizing the user interface.

In another aspect of the present disclosure, which may be used in combination with any other aspect or combination of aspects listed herein, the generated report is a virtual persona of customer attributes provided via the user interface.

### BRIEF DESCRIPTION OF THE DRAWINGS

FIG. 1 illustrates a flow diagram of a system performing the presently disclosed method, according to an embodiment of the present disclosure.

FIG. 2 illustrates a flow chart of the different processes of the disclosed method, according to an embodiment of the present disclosure.

### DETAILED DESCRIPTION

The present disclosure provides a method and system for rapid customer segmentation and customer behavior research by leveraging a combination of algorithmic approaches. The provided method enables a rapid, accurate and immediately actionable customer research tool that is available to a wide range of users with varying degrees of skill and expertise. Market research, such as customer segmentation, involves analyzing a tremendous amount of information about customers and harvesting value from this data. Marketers and businesses can better target specific customers when behavior patterns of customers who share specific attributes are known.

As used herein, the term “Key Performance Indicator” (“KPI”) means a critical indicator of progress toward an intended result. More specifically, a KPI is a context specific metric and/or indicator that an organization uses to gauge the process, success, of an initiative and/or project. A KPI provides focus for strategic and operational improvement, creates an analytical basis for decision making and helps focus attention on an organization's specific goal. For example, in the context of a sales organization, KPIs may include: percentage of overdue invoices; percentage of purchase orders raised in advance; finance report error rate; average cycle time of workflow; and/or number of duplicate payments. Additionally, for example, in the context of an organization that engages in marketing to a customer, KPIs may include: new customer acquisition; status of existing customers; customer attrition; revenue generated by segments of the customer population; and/or outstanding balances held by segments of customers.

In an embodiment, the disclosed method is used to analyze customer data to detect behavioral patterns, analyze associated demographic information and classify customers based on discrete segments. Additionally, the customer data is analyzed against specified KPIs, resulting in contextualized and immediately actionable customer segmentation. Using KPIs when analyzing customer behavior allows for rapid, contextualized, and immediately actionable customer segmentation data

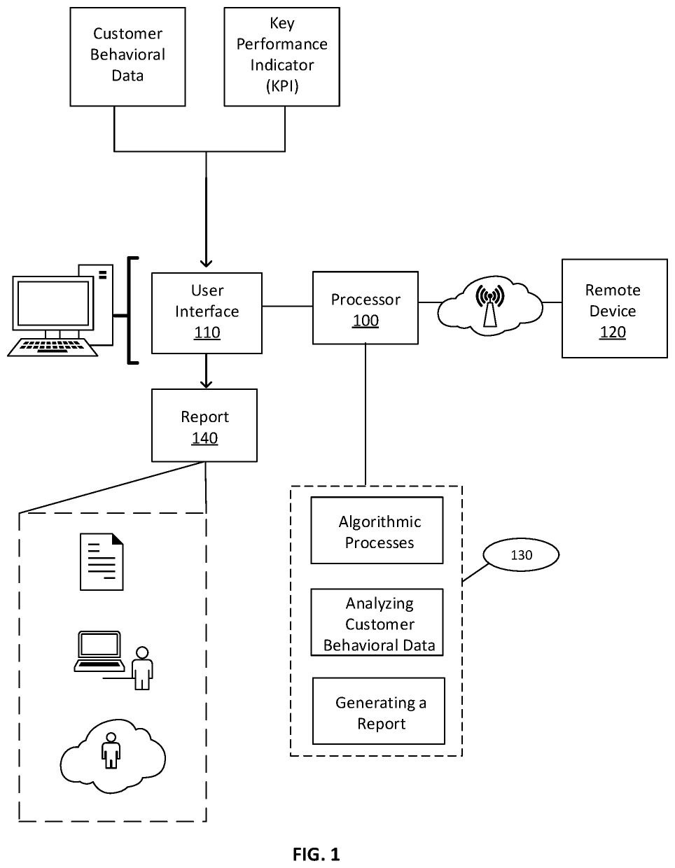

FIG. 1 illustrates a flow diagram of a system performing the presently disclosed method, according to an embodiment of the present disclosure.

Referring to FIG. 1, in an embodiment, the method for rapid analysis of customer information includes providing at least one processor 100 capable of connecting to a network and connecting the processor to a network facilitating communication with at least one remote device 120. In an embodiment, the method includes providing a user interface 110 in operable communication with the processor 100. The user interface 110 may be used to input commands to the processor. In an embodiment, the user interface 110 is a graphical user interface (GUI). For example, text-based user interfaces such as a keyboard may be employed. In an additional embodiment, virtual or audio based user interfaces may be employed.

In an embodiment, the presently disclosed method includes providing one or more processor-executable instructions 130 to the processor 110. The processor-executable instructions 130 causes the processor 100 execute the instructions 130 in response to an input. For example, the processor-executable instructions 130 may be provided via the user interface 110 or via the network connection originating from a remote device 120. In an embodiment, the method includes providing customer behavioral data and providing at least one KPI to the processor 100 via the user interface 110. In an embodiment, the customer behavioral data and at least one KPI is provided via the user interface 110 or via the network connection originating from the remote device 120.

The processor-executable instructions 130 may be stored on a local memory device in operable connection with the processor 100 or stored on a remote device 120, accessible via the network connection. In an embodiment, processor-executable instructions 130 include at least one algorithmic process for analyzing data in a manner that allows for descriptive and predictive analysis and instructions to analyze customer behavioral data in view of a KPI. In an embodiment, analyzing customer behavior utilizing algorithmic processes involves identifying customer behavioral patterns as it relates to the provided KPI, automatically classifying the behavioral patterns identified into discrete segments and compressing the resulting discrete segments into narrower, unique segments. For example, identified patterns may be classified into discrete segments based on the demographic, geographic, psychographic, behavioral and/or contextual information of the customer. along with any combination of these groups. Also, the identified patterns may be classified by specific business goals or by groupings of KPIs either grouped by the user via the dashboard or grouped automatically by the system. In an embodiment, the algorithmic analysis involves compressing the resulting discrete segments into narrower, unique sub-segments that more specifically define the customer who exhibits the particular behavioral pattern.

Still referring to FIG. 1, the presently disclosed method next involves generating a report 140 of the patterns identified, including actionable applications of the report. In an embodiment, processor-executable instructions 130 are provided to instruct the processor 100 to render the results of the algorithmic analysis in the form of a report 140 to the user through the user interface 110. For example, the report 140 can be a memo style document that explains the patterns detected during the previous steps of the presently disclosed method and the different segments used to classify the customer data. The report can be provided to the user of the method through a user graphical display (i.e. monitor) or auditory user interface (i.e. speaker).

In another embodiment, the generated report 140 can be in the form of a virtual persona of a customer that explains the patterns applicable to that particular customer and the specific segments that individual customer is classified into. In an embodiment, the generated report that is generated in the form of a virtual persona maybe provided to the user via a virtual user interface.

In another embodiment, the presently disclosed method is simultaneously carried out by multiple users on a plurality of remote devices 120 connected to a network.

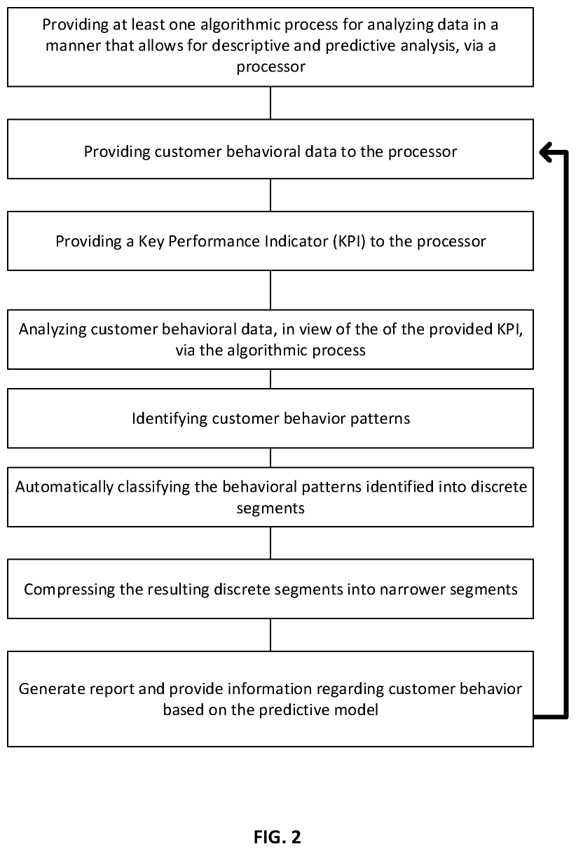

FIG. 2 illustrates a flow chart of the different processes of the disclosed method, according to an embodiment of the present disclosure. In an embodiment, the method includes providing at least one processor capable of connecting to a network and connecting the processor to the network thereby facilitating communication with at least one remote device. In an embodiment, the network is the internet. In an additional embodiment, the network may be a local area network. In another embodiment, the presently disclosed method is simultaneously carried out by multiple users on a plurality of remote devices connected to a network.

In an embodiment, the method includes providing a user interface in operable communication with the processor, wherein the user interface is used to input commands to the processor. In an embodiment, the user interface is a graphical user interface (GUI). For example, text-based user interfaces such as a keyboard may be employed. In an additional embodiment, virtual or audio based user interfaces may be employed. One or more processor-executable instructions are also provided that instruct the processor to render an interface through the user interface to allow a user to input data to the processor. For example, in an embodiment, the processor provides a user friendly and intuitive interface that allows the user of the method to manually type data into a dialog box or upload data files to the interface to be analyzed according to the presently disclosed method.

In an embodiment, the user interface is a customizable web page, accessible via a remote device connected to a network that allows for data to be provided and analyzed. For example, an organization utilizing the method may access the user interface webpage and provide customer behavioral data and organization specific KPIs in order to analyze behavioral data and generate and actionable report. The user interface webpage maybe customized and tailored to the specific needs of the user utilizing the presently disclosed method.

Referring to FIG. 2, in an embodiment, the presently disclosed method includes providing one or more processor-executable instructions to the processor, wherein providing the processor-executable instructions causes the processor to execute the instructions in response to the input. The processor-executable instructions may be stored on a local memory device in operable connection with the processor or stored on a remote device, accessible via the network. In an embodiment, processor-executable instructions include at least one algorithmic process for analyzing data in a manner that allows for descriptive and predictive analysis. The algorithmic process may be selected via an specifically designed user segmentation interface dashboard or automatically recommended by the system based on business goals or KPIs from the group of supervised learning, unsupervised learning, semi-supervised learning, regression algorithms, regularization algorithms, decision tree algorithms, Bayesian algorithms, clustering algorithms, association rule learning algorithms and/or artificial neural network algorithms.

In an embodiment, descriptive analysis involves utilizing algorithmic processes to gain an understanding of the information currently in possession of the user of the method. For example, an organization utilizing the presently disclosed method can gain a broader and more detailed description of its customers by analyzing the information it already possesses to gain insights that the organization can leverage for the achievement of segmentation to support the achievement of business goals or one of more KPI(s).

In an embodiment, predictive analysis involves utilizing algorithmic processes to forecast or predict future customer behavior and/or preferences based on information currently in possession of the user of the method. For example, an organization utilizing the presently disclosed method can gain an understanding of how customer behavior may change over time based on existing data sets of behavioral patterns. From this predictive analysis, the system can recommend segmentation methodologies that best achieve this goal(s).

Still referring to FIG. 2, in an embodiment, the presently disclosed method includes providing customer behavioral data, via the user interface, to the processor. For example, individual customer data may be provided to the processor using a graphical user interface, such as a keyboard and monitor. In an additional embodiment, a data set containing customer data for a plurality of different customers may be uploaded to the user interface webpage and provided to the processor via the network. Similarly, the presently disclosed method includes providing at least one KPI, via the user interface, to the processor. In an embodiment, the KPI is provided to the processor in the same manner as the customer behavioral data.

In another embodiment, data is passively entered into the interface by instructing the processor to collect data from various locations via the network. For example, processor-executable instructions can be provided to instruct the processor to collect behavioral information regarding a plurality of customers from e-commerce websites, travel websites, utility account websites, email accounts, etc. Additionally, the processor-executable instructions can also instruct the processor to populate that information into the tailored interface for analysis according to the presently disclosed method.

In an embodiment, the data provided can consist of customer behavioral data such as purchasing behavior, data usage, number of product inquires/refunds requested, reviews written, location data and/or any other touchpoint an organization has with a customer. In addition to customer behavior data, customer demographic information is also helpful in providing accurate customer segmentation analysis. For example, gender, age, national origin and primary language spoken are all extremely useful data points to analyze in conjunction with behavioral information. By providing this information, further steps of the disclosed method can be utilized to generate patterns between customer behavior and customer demographics.

In an embodiment, still referring to FIG. 2, the presently disclosed method includes analyzing customer behavioral data in view of the provided Key Performance Indicator, via the at least one algorithmic process executed by the processor. In an embodiment, analyzing the customer behavioral date includes identifying customer behavioral patterns as it relates to the provided KPI, automatically classifying the behavioral patterns identified into discrete segments and compressing the resulting discrete segments into narrower, unique segments. In an embodiment, the provided KPIs are user-specific KPIs meaning the organization utilizing the presently disclosed method selects the specific KPI based on the ideal metric or indicator that will most accurately gauge the progress or success of an initiative or project the organization is conducting. For example, profitability of customers by demographic segments, new customer acquisition, demographics of existing customers, customer attrition, customer turnover and/or outstanding balances held by segments of customers are all helpful indicators of an organization's performance.

In an embodiment, identifying customer behavioral patterns within datasets of one or more types as it relates to the provided KPI involves comparing customer behavioral data can be against company specific KPIs to generate contextualized and immediately actionable customer segmentation information. In an embodiment, the presently disclosed method identifies patterns that exist between customer behavioral data, customer demographic data and organization specific KPIs. For example, the standardized backend algorithmic processes might detect that customers of a specific age range and nationality purchase a specific product more often than a different age range and nationality. For example, the system may also employ complex machine learning, deep learning, statistical methods, and/or artificial intelligence in unique combinations based on the business goals or KPIs to identify latent connections between or among behaviors for insights into customer segment behavior that base statistical analysis would not detect. In an embodiment, these patterns are recorded and further analyzed according to the presently disclosed method.

In an embodiment, automatically classifying the behavioral patterns identified into discrete segments and compressing the resulting discrete segments into narrower, unique segments involves identifying patterns and classifying the patterns into discrete segments based on the demographic, geographic, psychographic, behavioral and/or contextual information of the customer. In an embodiment, the presently disclosed method classifies customer preferences into discrete segments based on a plurality of attributes. For example, the algorithmic process detects that males between the ages of 50-65 purchase a specific product more frequently than other demographics. The disclosed method then begins building discrete segments for a plurality of customer behavior data points based on the patterns learned. In another embodiment, the presently disclosed method of automatically classifying customer preferences includes predicting possible future preferences.

In an embodiment, the algorithmic analysis involves compressing the resulting discrete segments into narrower, unique sub-segments that more specifically define the customer who exhibits the particular behavioral pattern. For example, as previously described, the algorithmic process detects that males between the ages of 50-65 purchase a specific product more frequently than other demographics. The provided algorithmic approaches then determine if that segmentation can be compressed more narrowly based on additional data points. Now, the algorithmic process detects that males between the ages of 50-65 of eastern European nationality purchase a specific product more frequently than other demographics. Providing the further compressed customer segment data allows users of the method to target customers with new initiatives on a granular level.

In an embodiment, the at least one algorithmic process executed by the processor may be standardized backend algorithmic processes for analyzing data known to an ordinarily skilled artesian.

Still referring to FIG. 2, the presently disclosed method next involves generating a report of the patterns identified, including actionable applications of the report. In an embodiment, processor-executable instructions are provided to instruct the processor to render the results of the algorithmic analysis in the form of a report to the user through the user interface. For example, the report can be a memo style document that explains the patterns detected during the previous steps of the presently disclosed method and the different segments used to classify the customer data. The report can be provided to the user of the method through a graphical user interface (i.e. display or monitor) or auditory user interface (i.e. speaker).

In another embodiment, the generated report can be in the form of a list of contextualized and immediately actionable initiatives that the user of the presently disclosed method can select from and implement. For example, as previously described, the algorithmic process detects that females between the ages of 22-35, geographically located western European, purchase a specific product more frequently than other demographics. In this embodiment, the report would include suggestions of immediately actionable initiatives such as utilizing social media channels or a list of public figures/influencers that are most popular in that specific segment to potentially contact regarding a marketing campaign. Additionally, the immediately actionable initiatives may include pricing strategies and/or product diversification strategies.

In another embodiment, the generated report can be in the form of a virtual persona of a customer that explains the patterns applicable to that particular customer and the specific segments that individual customer is classified into.

In an embodiment, the generated report that is generated in the form of a virtual persona maybe provided to the user via a virtual user interface.

In another embodiment, the generated report can be in the form of a virtual persona of a customer that explains the patterns applicable to that particular customer and the specific segments that individual customer is classified into. Data-driven persona generation can be used to create high-quality human representations from online analytics data to make the generated report more useful for decision makers. For example, instead of the report containing quantitative statistics regarding customer behavior in relation to user-specific KPIs, in an embodiment, the report may be a virtual persona that includes attributes and demographic information that represents an architype of a consumer that is associated with a behavior or KPI. Additionally, the virtual person may include a name, imagine and a plurality of demographic information that corresponds to the generated virtual persona. Furthermore, the virtual persona may be generated consistent with the methods discussed in Salminen, Joni & Jung, Soon-Gyo & Jansen, Jim. (2019). The Future of Data-driven Personas: A Marriage of Online Analytics Numbers and Human Attributes. 608-615. 10.5220/0007744706080615.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

The invention is claimed as follows:

1. A method for rapid customer data analysis, the method comprising:
providing at least one processor capable of connecting to a network;
connecting the processor to the network thereby facilitating communication with at least one remote device;
providing a user interface in operable communication with the processor, wherein the user interface is used to input commands to the processor;
providing one or more processor-executable instructions to the processor, wherein providing the processor-executable instructions causes the processor to execute the instructions in response to the input;
wherein the one or more processor-executable instructions includes at least one algorithmic process for analyzing data in a manner that allows for descriptive and predictive analysis;
providing customer behavioral data, via the user interface, to the processor;
providing at least one Key Performance Indicator, via the user interface, to the processor;
analyzing customer behavioral data in view of the provided Key Performance Indicator, via the at least one algorithmic process executed by the processor, wherein analyzing the customer behavioral date includes
identifying customer behavioral patterns as it relates to the provided Key Performance Indicator;
automatically classifying the behavioral patterns identified into discrete segments; and
compressing the resulting discrete segments into narrower, unique segments;
generating a report of the patterns identified, including actionable applications of the report.

2. The method of claim 1, wherein the user interface is selected from the group of a graphical user interface, an auditory user interface and a virtual user interface.

3. The method of claim 1, wherein the key performance indicators are user-specific key performance indicators.

4. The method of claim 1, wherein providing customer behavioral data to the processor may be accomplished using the at least one remote device, via the network.

5. The method of claim 1, wherein the generated report includes a list of the patterns identified and a list of discrete classification segments provided to the user utilizing the user interface.

6. The method of claim 1, wherein the generated report is a virtual persona of customer attributes provided via the user interface.

7. The method of claim 1, wherein the generated report includes at least one actionable initiative.

8. A computer-implemented method, comprising:
providing at least one processor capable of connecting to a network;
providing a user interface in operable communication with the processor, wherein the user interface is used to input commands to the processor;
providing one or more processor-executable instructions to a processor, wherein providing the processor-executable instructions causes the processor to execute the instructions in response to the input;
wherein the one or more processor-executable instructions includes at least one algorithmic process for analyzing data in a manner that allows for descriptive and predictive analysis;
providing customer behavioral data, via the user interface, to the processor;
providing at least one Key Performance Indicator, via the user interface, to the processor;
analyzing customer behavioral data in view of the provided Key Performance Indicator, via the at least one algorithmic process executed by the processor, wherein analyzing the customer behavioral date includes
identifying customer behavioral patterns as it relates to the provided Key Performance Indicator;
automatically classifying the behavioral patterns identified into discrete segments; and
compressing the resulting discrete segments into narrower, unique segments;
generating a report of the patterns identified, including actionable applications of the report.

9. The method of claim 7, wherein the user interface is selected from the group of a graphical user interface, an auditory user interface and a virtual user interface.

10. The method of claim 7, wherein the key performance indicators are user-specific key performance indicators.

11. The method of claim 7, wherein providing customer behavioral data to the processor may be accomplished using the at least one remote device, via the network.

12. The method of claim 7, wherein the generated report includes a list of the patterns identified and a list of discrete classification segments provided to the user utilizing the user interface.

13. The method of claim 7, wherein the generated report is a virtual persona of customer attributes provided via the user interface.

14. The method of claim 7, wherein the generated report includes at least one actionable initiative.

15. A customer behavior analysis system, the system comprising:
at least one processor capable of connecting to a network;
at least one remote device capable of connecting to the network;
a user interface operatively coupled to the processor, the interface configured to receive an input;
a memory device storing processor-executable instructions, wherein the one or more processor-executable instructions includes at least one algorithmic process for analyzing data in a manner that allows for descriptive and predictive analysis; wherein the analysis includes
providing customer behavioral data, via the user interface, to the processor;
providing at least one Key Performance Indicator, via the user interface, to the processor;
analyzing customer behavioral data in view of the provided Key Performance Indicator, via the at least one algorithmic process executed by the processor, wherein analyzing the customer behavioral date includes
identifying customer behavioral patterns as it relates to the provided Key Performance Indicator;
automatically classifying the behavioral patterns identified into discrete segments; and
compressing the resulting discrete segments into narrower, unique segments;
generating a report of the patterns identified, including actionable applications of the report.

16. The system of claim 15, wherein the user interface is selected from the group of a graphical user interface, an auditory user interface and a virtual user interface.

17. The system of claim 15, wherein the key performance indicators are user-specific key performance indicators.

18. The system of claim 15, wherein providing customer behavioral data to the processor may be accomplished using the at least one remote device, via the network.

19. The system of claim 15, wherein the generated report includes a list of the patterns identified and a list of discrete classification segments provided to the user utilizing the user interface.

20. The system of claim 15, wherein the generated report is a virtual persona of customer attributes provided via the user interface.
